(19) United States
(12) Patent Application Publication
(10) Pub. No.: US 2018/0311707 A1
(43) Pub. Date: Nov. 1, 2018

(54) IN SITU CLEAN USING HIGH VAPOR PRESSURE AEROSOLS

(71) Applicant: LAM RESEARCH CORPORATION, Fremont, CA (US)

(72) Inventors: Travis R. Taylor, Portland, OR (US); Adam Bateman, Fremont, CA (US)

(21) Appl. No.: 15/950,658

(22) Filed: Apr. 11, 2018

Related U.S. Application Data
(60) Provisional application No. 62/492,561, filed on May 1, 2017.

(51) Int. Cl. B08B 5/02; B08B 7/00

(52) U.S. Cl. CPC B08B 5/02; B08B 7/0021

(57) ABSTRACT

A method for cleaning a chamber of a substrate processing system includes maintaining the chamber at a first predetermined pressure and, without a substrate present within the chamber, providing, from a fluid source via a nozzle assembly, a fluid, and injecting the fluid into the chamber via the nozzle assembly. The fluid source is maintained at a second predetermined pressure that is greater than the first predetermined pressure. Injecting the fluid into the chamber maintained at the first predetermined pressure causes the fluid to aerosolize into a mixture of gas and solid particles.

### CROSS-REFERENCE TO RELATED APPLICATIONS

This application claims the benefit of U.S. Provisional Application No. 62/492,561, filed on May 1, 2017. The entire disclosure of the application referenced above is incorporated herein by reference.

### FIELD

The present disclosure relates to cleaning components in a substrate processing system.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Substrate processing systems may be used to treat substrates such as semiconductor wafers. Example processes that may be performed on a substrate include, but are not limited to, chemical vapor deposition (CVD), atomic layer deposition (ALD), conductor etch, rapid thermal processing (RTP), ion implant, physical vapor deposition (PVD), and/or other etch, deposition, or cleaning processes. A substrate may be arranged on a substrate support, such as a pedestal, an electrostatic chuck (ESC), etc. in a processing chamber of the substrate processing system. During processing, gas mixtures including one or more precursors may be introduced into the processing chamber and plasma may be used to initiate chemical reactions.

The processing chamber includes various components including, but not limited to, the substrate support, a gas distribution device (e.g., a showerhead, which may also correspond to an upper electrode), a plasma confinement shroud, etc. The substrate support may include a ceramic layer arranged to support a substrate. For example, the substrate may be clamped to the ceramic layer during processing. The substrate support may include an edge ring arranged around an outer portion (e.g., outside of and/or adjacent to a perimeter) of the substrate support. The edge ring may be provided to confine plasma to a volume above the substrate, protect the substrate support from erosion caused by the plasma, etc. The plasma confinement shroud may be arranged around each of the substrate support and the showerhead to further confine the plasma within the volume above the substrate.

### SUMMARY

A method for cleaning a chamber of a substrate processing system includes maintaining the chamber at a first predetermined pressure and, without a substrate present within the chamber, providing, from a fluid source via a nozzle assembly, a fluid, and injecting the fluid into the chamber via the nozzle assembly. The fluid source is maintained at a second predetermined pressure that is greater than the first predetermined pressure. Injecting the fluid into the chamber maintained at the first predetermined pressure causes the fluid to aerosolize into a mixture of gas and solid particles. The method further includes purging the chamber.

In other features, injecting the fluid includes injecting the fluid in a plurality of pulses. Injecting the fluid includes alternately injecting the fluid and purging the chamber. Injecting the fluid via the nozzle assembly includes injecting the fluid via a plurality of the nozzle assemblies. Injecting the fluid via the plurality of the nozzle assemblies includes sequentially injecting the fluid via the plurality of the nozzle assemblies.

In other features, the method further includes adjusting a position of the nozzle assembly. Adjusting the position of the nozzle assembly includes rotating the nozzle assembly. The method further comprising injecting the fluid into the chamber in response to a signal indicating a cleanliness of the chamber.

In other features, the fluid includes at least one of carbon dioxide (CO₂), argon (Ar), sulfur hexafluoride (SF₆), butane (C₄H₈), propane (C₃H₆), ethylene (C₂H₄), nitrous oxide (N₂O), ammonia (NH₃), krypton (Kr), xenon (Xe), radon (Rn), nitrogen trifluoride (NF₃), sulfur dioxide (SO₂), and hydrogen chloride (HCl). The first pressure is less than 720 torr and the second pressure is greater than 720 torr. The chamber corresponds to at least one of a load lock and a substrate processing chamber.

A controller for a substrate processing system includes a pump control module configured to control a pressure within a chamber of the substrate processing system and a cleaning process control module. The cleaning process control module is configured to, without a substrate present in the chamber, control the pump control module to maintain the chamber at a first predetermined pressure, provide, from a fluid source via a nozzle assembly, a fluid, inject the fluid into the chamber via the nozzle assembly, and, subsequent to injecting the fluid into the chamber, control the pump control module to purge the chamber. The fluid source is maintained at a second predetermined pressure that is greater than the first predetermined pressure and injecting the fluid into the chamber maintained at the first predetermined pressure causes the fluid to aerosolize into a mixture of gas and solid particles.

In other features, to inject the fluid, the cleaning process control module is further configured to inject the fluid in a plurality of pulses. To inject the fluid, the cleaning process control module is further configured to alternately inject the fluid and purge the chamber. To inject the fluid via the nozzle assembly, the cleaning process control module is further configured to inject the fluid via a plurality of the nozzle assemblies. To inject the fluid via the plurality of the nozzle assemblies, the cleaning process control module is further configured to sequentially inject the fluid via the plurality of the nozzle assemblies.

In other features, the cleaning process control module is further configured to adjust a position of the nozzle assembly. To adjust the position of the nozzle assembly, the cleaning process control module is further configured to rotate the nozzle assembly. To inject the fluid, the cleaning process control module is further configured to inject the fluid into the chamber in response to a signal indicating a cleanliness of the chamber. The fluid includes at least one of carbon dioxide (CO₂), argon (Ar), sulfur hexafluoride (SF₆), butane (C₄H₈), propane (C₃H₆), ethylene (C₂H₄), nitrous oxide (N₂O), ammonia (NH₃), krypton (Kr), xenon (Xe), radon (Rn), nitrogen trifluoride (NF₃), sulfur dioxide (SO₂), and hydrogen chloride (HCl).

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a substrate processing system according to the principles of the present disclosure.

FIG. 2A is an example aerosol delivery system according to the principles of the present disclosure.

FIG. 2B is a first example nozzle assembly according to the principles of the present disclosure.

FIG. 2C is a second example nozzle assembly according to the principles of the present disclosure.

FIG. 3 is an example controller configured to implement a cleaning process according to the principles of the present disclosure.

FIG. 4 illustrates an example method for performing a cleaning process according to the principles of the present disclosure.

In the drawings, reference numbers may be reused to identify similar and/or identical elements.

### DETAILED DESCRIPTION

Components arranged within a processing chamber of a substrate processing system include, but are not limited to, a gas distribution device (e.g., a showerhead), a plasma confinement shroud, and/or a substrate support including a baseplate, one or more edge rings, coupling rings, etc. These and other components are fabricated, using various fabrication processes, outside of the processing chamber. Components may also be removed from the processing chamber for repair, cleaning, resurfacing, replacement, etc.

Components within the processing chamber that may affect processing of a substrate may be referred to as critical chamber parts. Accordingly, defects (e.g., particles, nanometer-sized defects, metal contaminants, etc.) associated with the components introduced into the processing chamber may interfere with processing of the substrate. For example, defects may adhere to components that are fabricated, machined, cleaned, etc. outside of the processing chamber and may therefore be brought into the processing chamber with the components. Cleaning may include wet processes that use acids, bases, sonication, detergents, etc. prior to installing components and assembling the processing chamber.

Subsequent to assembling the processing chamber, precision cleaning the entire chamber may not be feasible. For example, cleaning the processing chamber may be desirable immediately after initial assembly. Further, the processing chamber may require cleaning after a period of normal operation due to defects accumulated during processing, defects brought in with substrates, etc. Some components may be removed and cleaned outside of the chamber (i.e., ex situ). However, ex situ cleaning may involve complicated procedures that increase costs and system downtime. Accordingly, the processing chamber and its components may be cleaned with clean room wipes (e.g., material soaked in an isopropyl alcohol and water solution). In some examples, cleaning processes include venting/purging the substrate processing system (e.g., venting the chamber, load locks, etc.) and subsequently pumping down the substrate processing system to return to vacuum. In other words, vacuum is broken. In other examples, breaking vacuum is avoided by performing multiple pump/vent cycles. In a pump/vent cycle, a gas is pumped into a chamber and is subsequently vented. However, cleaning efficiency using multiple pump/vent cycles is very low. For example, thousands of pump/vent cycles (e.g., 9000 or more) may be required to clean a processing chamber, load lock, or other chamber of the substrate processing system.

Systems and methods according to the principles of the present disclosure implement a cleaning process that uses solid particles in one or more pulse/purge cycles. Solid particles dislodge and remove defect particles from components of a chamber more efficiently than using gas alone. Further, the cleaning process uses solid particles that consist of materials that do not contribute to an overall amount of defect particles within the chamber. In one example, the cleaning process uses aerosolized dry ice particles (i.e., C₂). Subsequent to the cleaning process, any CO₂ particles remaining within the chamber sublimate (i.e., return to gas form) and can be removed with one or more pump/vent cycles. Other suitable materials include, but are not limited to, argon (Ar), sulfur hexafluoride (SF₆), butane (C₄H₈), propane (C₃H₆), ethylene (C₂H₄), nitrous oxide (N₂O), ammonia (NH₃), krypton (Kr), xenon (Xe), radon (Rn), nitrogen trifluoride (NF₃), sulfur dioxide (SO₂), and hydrogen chloride (HCl).

Although described with respect to the processing chamber (e.g., a substrate processing chamber), the principles of the present disclosure may also be implemented within other chambers of the substrate processing system, including, but not limited to, equipment front end modules (EFEMs), load locks, vacuum transfer modules (VTMs), etc.

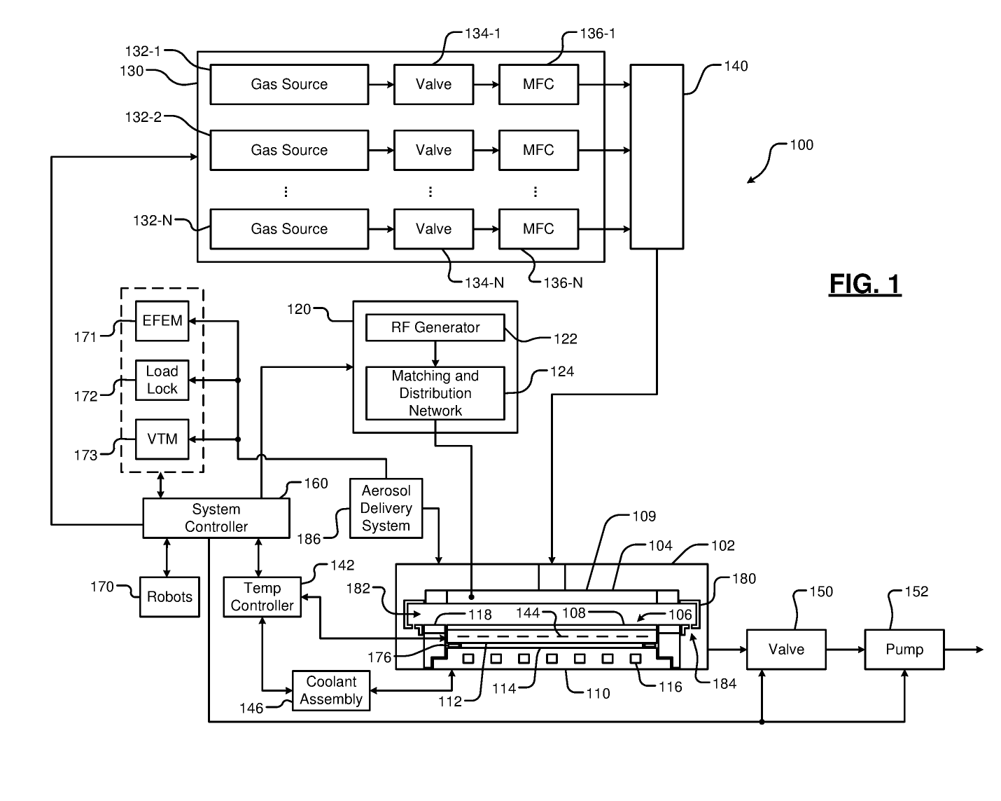

Referring now to FIG. 1, an example substrate processing system 100 is shown to illustrate various types of processing chamber components to be processed using the ultra-low defect part process and in-line particle and metal contamination checking process described below. For example only, the substrate processing system 100 may be used for performing deposition and/or etching using RF plasma and/or other suitable substrate processing. The substrate processing system 100 includes a processing chamber 102 that encloses other components of the substrate processing system 100 and contains the RF plasma. The processing chamber 102 includes an upper electrode 104 and a substrate support 106, such as an electrostatic chuck (ESC). During operation, a substrate 108 is arranged on the substrate support 106. While a specific substrate processing system 100 and chamber 102 are shown as an example, the principles of the present disclosure may be applied to other types of substrate processing systems and chambers, such as a substrate processing system that generates plasma in-situ, that implements remote plasma generation and delivery (e.g., using a plasma tube, a microwave tube), etc.

For example only, the upper electrode 104 may include a gas distribution device such as a showerhead 109 that introduces and distributes process gases. The showerhead 109 may include a stem portion including one end connected to a top surface of the processing chamber. A base portion is generally cylindrical and extends radially outwardly from an opposite end of the stem portion at a location that is spaced from the top surface of the processing chamber. A substrate-facing surface or faceplate of the base portion of the showerhead includes a plurality of holes through which process gas or purge gas flows. Alternately, the upper electrode 104 may include a conducting plate and the process gases may be introduced in another manner.

The substrate support 106 includes a conductive baseplate 110 that acts as a lower electrode. The baseplate 110 supports a ceramic layer 112. In some examples, the ceramic layer 112 may comprise a heating layer, such as a ceramic multi-zone heating plate. A thermal resistance layer 114 (e.g., a bond layer) may be arranged between the ceramic layer 112 and the baseplate 110. The baseplate 110 may include one or more coolant channels 116 for flowing coolant through the baseplate 110. The substrate support 106 may include an edge ring 118 arranged to surround an outer perimeter of the substrate 108.

An RF generating system 120 generates and outputs an RF voltage to one of the upper electrode 104 and the lower electrode (e.g., the baseplate 110 of the substrate support 106). The other one of the upper electrode 104 and the baseplate 110 may be DC grounded, AC grounded or floating. For example only, the RF generating system 120 may include an RF voltage generator 122 that generates the RF voltage that is fed by a matching and distribution network 124 to the upper electrode 104 or the baseplate 110. In other examples, the plasma may be generated inductively or remotely. Although, as shown for example purposes, the RF generating system 120 corresponds to a capacitively coupled plasma (CCP) system, the principles of the present disclosure may also be implemented in other suitable systems, such as, for example only transformer coupled plasma (TCP) systems, CCP cathode systems, remote microwave plasma generation and delivery systems, etc.

A gas delivery system 130 includes one or more gas sources 132-1, 132-2, . . . , and 132-N (collectively gas sources 132), where N is an integer greater than zero. The gas sources supply one or more gas mixtures. The gas sources may also supply purge gas. Vaporized precursor may also be used. The gas sources 132 are connected by valves 134-1, 134-2, . . . , and 134-N (collectively valves 134) and mass flow controllers 136-1, 136-2, . . . , and 136-N (collectively mass flow controllers 136) to a manifold 140. An output of the manifold 140 is fed to the processing chamber 102. For example only, the output of the manifold 140 is fed to the showerhead 109.

A temperature controller 142 may be connected to a plurality of heating elements, such as thermal control elements (TCEs) 144 arranged in the ceramic layer 112. For example, the heating elements 144 may include, but are not limited to, macro heating elements corresponding to respective zones in a multi-zone heating plate and/or an array of micro heating elements disposed across multiple zones of a multi-zone heating plate. The temperature controller 142 may be used to control the plurality of heating elements 144 to control a temperature of the substrate support 106 and the substrate 108.

The temperature controller 142 may communicate with a coolant assembly 146 to control coolant flow through the channels 116. For example, the coolant assembly 146 may include a coolant pump and reservoir. The temperature controller 142 operates the coolant assembly 146 to selectively flow the coolant through the channels 116 to cool the substrate support 106.

A valve 150 and pump 152 may be used to evacuate reactants from the processing chamber 102. A system controller 160 may be used to control components of the substrate processing system 100. One or more robots 170 may be used to deliver substrates onto, and remove substrates from, the substrate support 106. For example, the robots 170 may transfer substrates between an EFEM 171 and a load lock 172, between the load lock and a VTM 173, between the VTM 173 and the substrate support 106, etc. Although shown as separate controllers, the temperature controller 142 may be implemented within the system controller 160. In some examples, a protective seal 176 may be provided around a perimeter of the bond layer 114 between the ceramic layer 112 and the baseplate 110.

In some examples, the processing chamber 102 may include a plasma confinement shroud 180, such as a C-shroud. The C-shroud 180 is arranged around the upper electrode 104 and the substrate support 106 to confine plasma within a plasma region 182. In some examples, the C-shroud 180 comprises a semiconductor material, such as silicon carbide (SiC). The C-shroud 180 may include one or more slots 184 arranged to allow gases to flow out of the plasma region 182 to be vented from the processing chamber 102 via the valve 150 and the pump 152.

The substrate processing system 100 implements high vapor pressure aerosol cleaning systems and methods according to the principles of the present disclosure. For example, the substrate processing system 100 may include an aerosol delivery system 186 as described below in more detail.

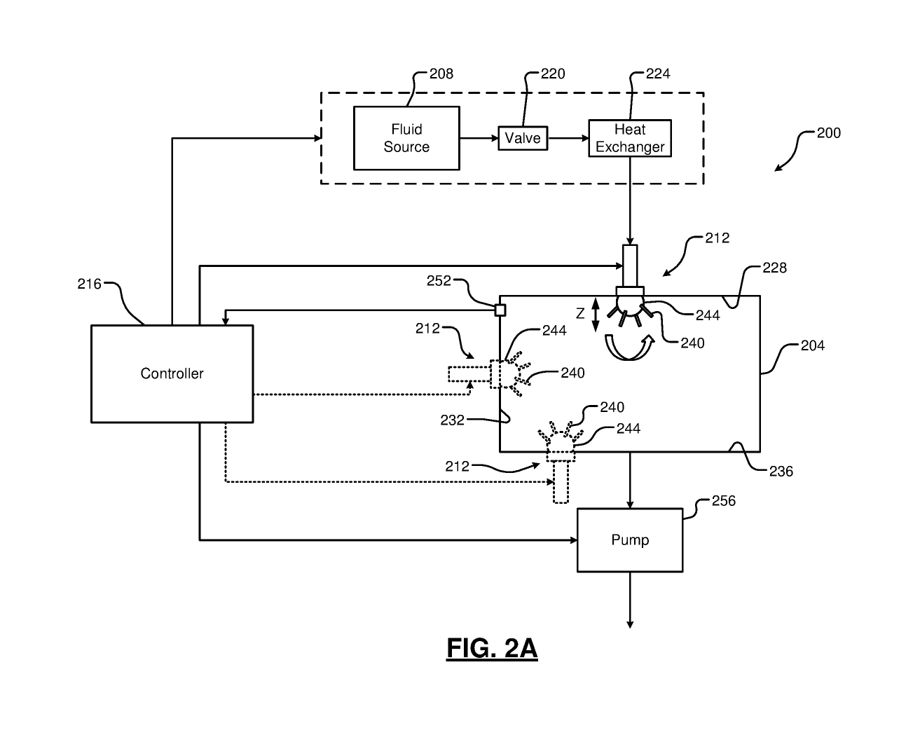

Referring now to FIGS. 2A, 2B, and 2C, an example aerosol delivery system 200 for providing aerosolized solid particles to a chamber 204 (e.g., a substrate processing chamber, a load lock, etc.) during a cleaning process is shown in more detail. The chamber 204 may correspond to, for example only, the processing chamber 102, the EFEM 171, the load lock 172, the VTM 173, etc. The chamber 204 may be maintained at various vacuum pressures during the cleaning process.

The aerosol delivery system 200 includes a fluid source 208 and a nozzle assembly 212. The fluid source 208 stores a cleaning gas (e.g., CO₂), a mixture of gases, etc. The fluid source 208 may be pressurized (i.e., the cleaning gas is stored under pressure as a liquid). A controller 216 (e.g., corresponding to the system controller 160) selectively opens and closes a valve 220 to provide the pressurized gas to the nozzle assembly 212. The nozzle assembly 212 is configured to allow rapid vacuum expansion of the pressurized gas, causing at least a portion of the molecules to condense into solid particles. The nozzle assembly 212 injects a mixture of gas and solid particles into the chamber 204. For example, as the pressurized gas flows from the source 208, through the aerosol delivery system 200 and into the chamber 204 under vacuum, the pressurized gas undergoes rapid (e.g., supersonic) expansion, causing rapid cooling and a transition to solid particles. In some examples, the aerosol delivery system 200 may include a heat exchanger 224 or other structure to facilitate cooling. In some examples, components of the aerosol delivery system 200 such as the fluid source 208, the valve 220, and/or the heat exchanger may be implemented within a gas delivery system such as the gas delivery system 130 of FIG. 1.

As shown, the nozzle assembly 212 is arranged in an upper wall 228 of the chamber 204. In other examples, the nozzle assembly 212 may be arranged in other locations, such as a sidewall 232 of the chamber 204, a bottom wall 236 of the chamber 204, etc. The aerosol delivery system 200 may include only one of the nozzle assemblies 212 or two or more of the nozzle assemblies 212 in multiple respective locations.

In some examples, the nozzle assembly 212 is fixed (i.e., the nozzle assembly 212 does not rotate, articulate, etc.). Accordingly, multiple nozzle assemblies 212 in various orientations may be provided such that the injected solid particles contact every surface within the chamber 204. In other examples, positions, orientations, etc. of one or more of the nozzle assemblies 212 are adjustable. For example, as shown, the nozzle assembly 212 includes two or more nozzles 240 arranged on a rotatable sphere 244. The sphere 244 is configured to rotate about a vertical axis through an X-Y plane (as shown in a bottom-up view in FIG. 2B) and/or about one or more horizontal axes through a Z plane as shown in FIG. 2A. In another example as shown in FIG. 2C, the nozzles 240 may be arranged on a cylindrical base 248 that is only rotatable about the vertical axis. The nozzle assemblies 212 may also be actuable in lateral and/or vertical directions (i.e., in a direction into and out of the chamber 204, in a direction parallel to the respective all of the chamber 204, etc.). The controller 216 may selectively adjust the position of the nozzle assemblies 212.

In still other examples, the aerosol delivery system 200 may be configured to provide the pressurized cleaning gas via an existing nozzle, injector, showerhead, or other gas distribution device of the chamber 204 (e.g., such as the showerhead 109). For example, the gas delivery system 130 may implement the aerosol delivery system 200.

During the cleaning process, the aerosol delivery system 200 may provide the pressurized gas in a pulsing pattern (e.g., via control of the valve 220 and/or the nozzle assembly 212, and a pressure of the chamber 204 may be oscillated between two or more vacuum pressures. In some examples, the pressurized gas may be provided continuously (e.g., the valve 220 is opened) while the pressure of the chamber 204 is oscillated. Since the pressure of the chamber 204 is lower than the pressure of the fluid source 208 and ambient pressure, the pressure of the chamber 204 determines a flow rate, velocity, etc. of the solid particles injected into the chamber 204. For example, the fluid source 208 may be maintained at a pressure between an ambient pressure and a greater pressure (e.g., between 720 and 6200 torr). The chamber 204 may be maintained at a pressure from less than 10 mtorr up to 10 torr, or, in some examples, up to ambient pressure.

The controller 216 may be configured to perform the cleaning process in an idle period (i.e., when the chamber 204 is not transferring and/or performing a process on a substrate) periodically, conditionally, etc. For example, the controller 216 may be configured to trigger the cleaning process a predetermined period subsequent to a previous instance that the cleaning process was performed, in response to a predetermined number of substrates being processed and/or transferred within the chamber 204, etc. In some examples, the chamber 204 may include one or more sensors 252 to detect a cleanliness of the chamber 204. For example, the sensor 252 may be configured to function as a particle counter that detects buildup of particles on the sensor 252. The controller 216 triggers the cleaning process in response to the particle buildup exceeding a first predetermined threshold. The cleaning process may be continued for a predetermined period, until the particle buildup is less than a second predetermined threshold, etc.

The cleaning process may include a plurality of pulse/purge cycles. For example, a pulse/purge cycle may include a first period where the aerosol delivery system 200 provides the pressurized gas to the nozzle assembly 212 followed by a second period where the controller 216 activates a pump 256 to purge the chamber. The cleaning process may include a predetermined number of the pulse/purge cycles, and/or the pulse/purge cycles may be repeated until a measured or estimated number of particles in the chamber 204 is below a threshold. In some examples, a purge gas (e.g., an inert gas) may be provided during the purging portion of the pulse/purge cycle. In other examples, the purge gas may be provided in a final venting of the chamber 204 subsequent to completion of the predetermined number of the pulse/purge cycles. Any remaining solid particles of the cleaning gas return to gas form and are removed from the chamber 204.

In some examples, the pressurized gas is provided to individual nozzle assemblies 212 in different phases of the pulse/purge cycles. In other words, only one of the nozzle assemblies 212 may inject the solid particles into the chamber 204 during a given pulse/purge cycle. In this manner, flows from each of the nozzle assemblies 212 do not compete with flows from others of the nozzle assemblies 212.

Various parameters of the aerosol delivery system 200 (e.g., type of gas, pressure, temperature, nozzle configuration, etc.) may be adjusted to optimize particle generation and delivery. For example, parameters may be adjusted to achieve a desired particle size, number of particles, particle velocity distribution, pressure, flow rate, pulsing duty cycle, pulsing frequency, etc.

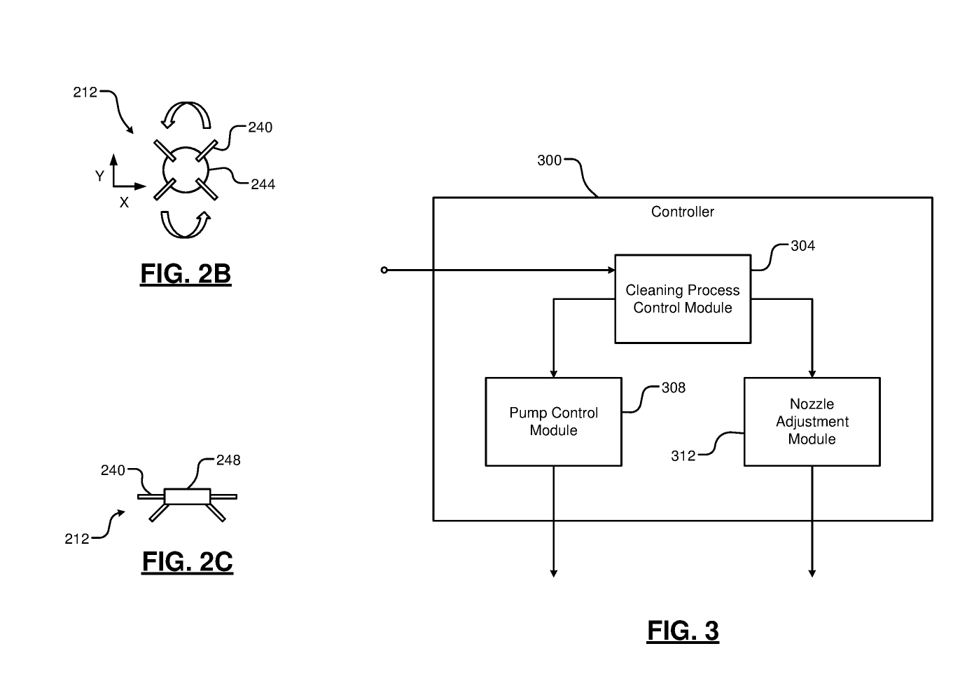

Referring now to FIG. 3, an example controller 300 is shown. For example, the controller 300 corresponds to the controller 216 described in FIG. 2. The controller 300 includes a cleaning process control module 304, a pump control module 308, and a nozzle adjustment module 312. The cleaning process control module 304 is configured to selectively initiate a cleaning process according to the principles of the present disclosure as described above in FIGS. 2A, 2B, and 2C.

For example, the cleaning process control module 304 may be configured to initiate the cleaning process periodically (e.g., a predetermined period subsequent to a previous cleaning process), in response to a predetermined number of substrates being processed, based on a measurement of particle buildup (e.g., based on a signal from a sensor, such as the sensor 252 of FIG. 2A), in response to a user input, etc. The cleaning process control module 304 may control the pump control module 308, the nozzle adjustment module 312, components of the aerosol delivery system 200 such as the valve 220, the heat exchanger 224, etc.

The pump control module 308 is configured to control the purging of the chamber 204, pumping the chamber 204 up/down to a desired pressure, etc. For example, the pump control module 308 is configured to control a pump (e.g., the pump 256 and associated valves) in response to commands from the cleaning process control module 304 during the cleaning process. The pump control module 308 may pump the chamber 204 down to a desired pressure prior to initiating the cleaning process, purge the chamber 204 during and/or subsequent to the cleaning process, etc. The nozzle adjustment module 312 is configured to adjust positions of the nozzle assemblies 212 in response to commands from the cleaning process control module 304.

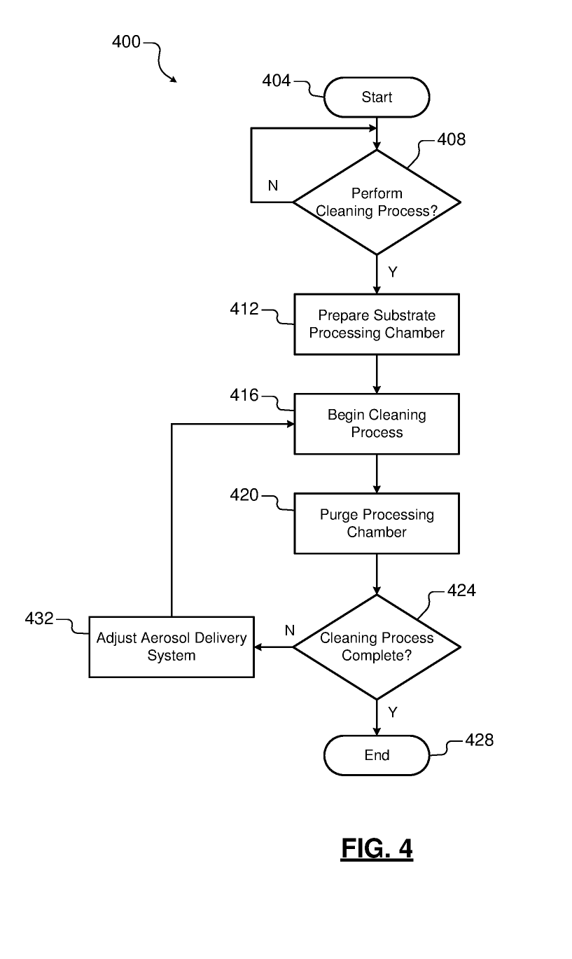

Referring now to FIG. 4, an example method 400 for performing the cleaning process according to the principles of the present disclosure begins at 404. For example, the method 400 begins when no substrate is present within the chamber 204. At 408, the method 400 (e.g., the controller 300) determines whether to perform the cleaning process. For example, the method 400 may determine whether to perform the cleaning process based on whether one or more conditions are met as described above in FIGS. 2A and 3 (e.g., periodically, in response to a predetermined number of substrates being processed, based on a measurement of particle buildup, etc.). If true, the method 400 continues to 412. If false, the method 400 continues to 408.

At 412, the method 400 (e.g., the controller 300) prepares the chamber 204 for the cleaning process. For example, the controller 300 pumps down the chamber 204 to a desired pressure, adjusts positions of the nozzle assemblies 212, etc. At 416, the method 400 (e.g., the controller 300) begins the cleaning process. For example, the controller 300 controls the aerosol delivery system 200 to inject aerosolized solid particles into the chamber 204 as described above in FIGS. 2A, 2B, and 2C. For example, the aerosolized solid particles may be injected in a single pulse or multiple pulses, and may be injected using only one or more than one of the nozzle assemblies 212. At 420, the method 400 (e.g., the controller 300) purges the chamber 204.

At 424, the method 400 (e.g., the controller 300) determines whether the cleaning process is complete. For example, the method 400 determines whether a predetermined number of injection pulses have been completed, whether the cleaning process has been performed for a predetermined period of time, etc. If true, the method 400 ends at 428. If false, the method 400 continues to 432. At 432, the method 400 (e.g., the controller 300) optionally adjusts components of the aerosol delivery system 200. For example, the method 400 may adjust positions of one or more of the nozzle assemblies 212, adjust a pressure within the chamber 204, etc. and then continue to 416. In a subsequent iteration of 416, the method 400 may inject the aerosolized solid particles using a same or different one of the nozzle assemblies 212.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In some implementations, a controller is part of a system, which may be part of the above-described examples. Such systems can comprise semiconductor processing equipment, including a processing tool or tools, chamber or chambers, a platform or platforms for processing, and/or specific processing components (a substrate pedestal, a gas flow system, etc.). These systems may be integrated with electronics for controlling their operation before, during, and after processing of a semiconductor substrate or substrate. The electronics may be referred to as the “controller,” which may control various components or subparts of the system or systems. The controller, depending on the processing requirements and/or the type of system, may be programmed to control any of the processes disclosed herein, including the delivery of processing gases, temperature settings (e.g., heating and/or cooling), pressure settings, vacuum settings, power settings, radio frequency (RF) generator settings, RF matching circuit settings, frequency settings, flow rate settings, fluid delivery settings, positional and operation settings, substrate transfers into and out of a tool and other transfer tools and/or load locks connected to or interfaced with a specific system.

Broadly speaking, the controller may be defined as electronics having various integrated circuits, logic, memory, and/or software that receive instructions, issue instructions, control operation, enable cleaning operations, enable endpoint measurements, and the like. The integrated circuits may include chips in the form of firmware that store program instructions, digital signal processors (DSPs), chips defined as application specific integrated circuits (ASICs), and/or one or more microprocessors, or microcontrollers that execute program instructions (e.g., software). Program instructions may be instructions communicated to the controller in the form of various individual settings (or program files), defining operational parameters for carrying out a particular process on or for a semiconductor substrate or to a system. The operational parameters may, in some embodiments, be part of a recipe defined by process engineers to accomplish one or more processing steps during the fabrication of one or more layers, materials, metals, oxides, silicon, silicon dioxide, surfaces, circuits, and/or dies of a substrate.

The controller, in some implementations, may be a part of or coupled to a computer that is integrated with the system, coupled to the system, otherwise networked to the system, or a combination thereof. For example, the controller may be in the “cloud” or all or a part of a fab host computer system, which can allow for remote access of the substrate processing. The computer may enable remote access to the system to monitor current progress of fabrication operations, examine a history of past fabrication operations, examine trends or performance metrics from a plurality of fabrication operations, to change parameters of current processing, to set processing steps to follow a current processing, or to start a new process. In some examples, a remote computer (e.g. a server) can provide process recipes to a system over a network, which may include a local network or the Internet. The remote computer may include a user interface that enables entry or programming of parameters and/or settings, which are then communicated to the system from the remote computer. In some examples, the controller receives instructions in the form of data, which specify parameters for each of the processing steps to be performed during one or more operations. It should be understood that the parameters may be specific to the type of process to be performed and the type of tool that the controller is configured to interface with or control. Thus as described above, the controller may be distributed, such as by comprising one or more discrete controllers that are networked together and working towards a common purpose, such as the processes and controls described herein. An example of a distributed controller for such purposes would be one or more integrated circuits on a chamber in communication with one or more integrated circuits located remotely (such as at the platform level or as part of a remote computer) that combine to control a process on the chamber.

Without limitation, example systems may include a plasma etch chamber or module, a deposition chamber or module, a spin-rinse chamber or module, a metal plating chamber or module, a clean chamber or module, a bevel edge etch chamber or module, a physical vapor deposition (PVD) chamber or module, a chemical vapor deposition (CVD) chamber or module, an atomic layer deposition (ALD) chamber or module, an atomic layer etch (ALE) chamber or module, an ion implantation chamber or module, a track chamber or module, and any other semiconductor processing systems that may be associated or used in the fabrication and/or manufacturing of semiconductor substrates.

As noted above, depending on the process step or steps to be performed by the tool, the controller might communicate with one or more of other tool circuits or modules, other tool components, cluster tools, other tool interfaces, adjacent tools, neighboring tools, tools located throughout a factory, a main computer, another controller, or tools used in material transport that bring containers of substrates to and from tool locations and/or load ports in a semiconductor manufacturing factory.

What is claimed is:

1. A method for cleaning a chamber of a substrate processing system, the method comprising:
maintaining the chamber at a first predetermined pressure;
without a substrate present within the chamber,
providing, from a fluid source via a nozzle assembly, a fluid, wherein the fluid source is maintained at a second predetermined pressure that is greater than the first predetermined pressure, and
injecting the fluid into the chamber via the nozzle assembly, wherein injecting the fluid into the chamber maintained at the first predetermined pressure causes the fluid to aerosolize into a mixture of gas and solid particles; and
purging the chamber.

2. The method of claim 1, wherein injecting the fluid includes injecting the fluid in a plurality of pulses.

3. The method of claim 1, wherein injecting the fluid includes alternately injecting the fluid and purging the chamber.

4. The method of claim 1, wherein injecting the fluid via the nozzle assembly includes injecting the fluid via a plurality of the nozzle assemblies.

5. The method of claim 4, wherein injecting the fluid via the plurality of the nozzle assemblies includes sequentially injecting the fluid via the plurality of the nozzle assemblies.

6. The method of claim 1, further comprising adjusting a position of the nozzle assembly.

7. The method of claim 6, wherein adjusting the position of the nozzle assembly includes rotating the nozzle assembly.

8. The method of claim 1, further comprising injecting the fluid into the chamber in response to a signal indicating a cleanliness of the chamber.

9. The method of claim 1, wherein the fluid includes at least one of carbon dioxide (CO₂), argon (Ar), sulfur hexafluoride (SF₆), butane (C₄H₈), propane (C₃H₆), ethylene (C₂H₄), nitrous oxide (N₂O), ammonia (NH₃), krypton (Kr), xenon (Xe), radon (Rn), nitrogen trifluoride (NF₃), sulfur dioxide (SO₂), and hydrogen chloride (HCl).

10. The method of claim 1, wherein the first pressure is less than 720 torr and the second pressure is greater than 720 torr.

11. The method of claim 1, wherein the chamber corresponds to at least one of a load lock and a substrate processing chamber.

12. A controller for a substrate processing system, the controller comprising:
a pump control module configured to control a pressure within a chamber of the substrate processing system; and
a cleaning process control module configured to, without a substrate present in the chamber,
control the pump control module to maintain the chamber at a first predetermined pressure,
provide, from a fluid source via a nozzle assembly, a fluid, wherein the fluid source is maintained at a second predetermined pressure that is greater than the first predetermined pressure,
inject the fluid into the chamber via the nozzle assembly, wherein injecting the fluid into the chamber maintained at the first predetermined pressure causes the fluid to aerosolize into a mixture of gas and solid particles, and
subsequent to injecting the fluid into the chamber, control the pump control module to purge the chamber.

13. The controller of claim 12, wherein, to inject the fluid, the cleaning process control module is further configured to inject the fluid in a plurality of pulses.

14. The controller of claim 12, wherein, to inject the fluid, the cleaning process control module is further configured to alternately inject the fluid and purge the chamber.

15. The controller of claim 12, wherein, to inject the fluid via the nozzle assembly, the cleaning process control module is further configured to inject the fluid via a plurality of the nozzle assemblies.

16. The controller of claim 15, wherein, to inject the fluid via the plurality of the nozzle assemblies, the cleaning process control module is further configured to sequentially inject the fluid via the plurality of the nozzle assemblies.

17. The controller of claim 12, wherein the cleaning process control module is further configured to adjust a position of the nozzle assembly.

18. The controller of claim 17, wherein, to adjust the position of the nozzle assembly, the cleaning process control module is further configured to rotate the nozzle assembly.

19. The controller of claim 12, wherein, to inject the fluid, the cleaning process control module is further configured to inject the fluid into the chamber in response to a signal indicating a cleanliness of the chamber.

20. The controller of claim 12, wherein the fluid includes at least one of carbon dioxide (CO₂), argon (Ar), sulfur hexafluoride (SF₆), butane (C₄H₈), propane (C₃H₆), ethylene (C₂H₄), nitrous oxide (N₂O), ammonia (NH₃), krypton (Kr), xenon (Xe), radon (Rn), nitrogen trifluoride (NF₃), sulfur dioxide (SO₂), and hydrogen chloride (HCl).
